(19) United States
(12) Patent Application Publication
(10) Pub. No.: US 2016/0065109 A1
(43) Pub. Date: Mar. 3, 2016

(54) POSITION ESTIMATION DEVICE, MOTOR DRIVE CONTROL DEVICE, POSITION ESTIMATION METHOD AND RECORDING MEDIUM

(71) Applicants: Norihiro YAMAMOTO, Kanagawa (JP); Haruyuki SUZUKI, Kanagawa (JP); Masayuki MURANAKA, Kanagawa (JP)

(72) Inventors: Norihiro YAMAMOTO, Kanagawa (JP); Haruyuki SUZUKI, Kanagawa (JP); Masayuki MURANAKA, Kanagawa (JP)

(73) Assignee: RICOH COMPANY, LTD., Tokyo (JP)

(21) Appl. No.: 14/824,432

(22) Filed: Aug. 12, 2015

(30) Foreign Application Priority Data
Aug. 29, 2014 (JP) 2014-175129

(51) Int. Cl. H02P 21/14; H02P 6/18

(52) U.S. Cl. CPC H02P 21/146; H02P 6/18; H02P 21/141

(57) ABSTRACT

A position estimation device for estimating a position of a rotator of a motor includes an estimation unit configured to estimate a rotational position of the rotator of the motor using a magnetic flux estimation value of the motor, which is calculated by inputting an electric voltage instruction value to be inputted to the motor and a coil electric current value detected from the motor into a motor model in which the motor is identified; and a derivation unit configured to derive a magnetic flux deviation amount due to a distortion of a magnetic flux waveform of the motor according to the estimated rotational position. The estimation unit corrects the magnetic flux estimation value based on the derived magnetic flux deviation amount, modifies the estimated rotational position based on the corrected magnetic flux estimation value, and outputs the modified rotational position.

### BACKGROUND OF THE INVENTION

1. Field of the Invention

The disclosures herein generally relate to a position estimation device, a motor drive control device, a position estimation method and a computer-readable recording medium storing a program for causing a computer to execute a process.

2. Description of the Related Art

Conventionally, in sensor-less motor drive control devices, a variety of position estimation methods have been proposed for estimating rotational positions of rotators of motors without using position sensors.

For example, Japanese Published Patent Application No. 2012-244735 discloses a method of estimating a rotational position by arranging an electric current detector for detecting an electric current of a coil of a motor, inputting an electric voltage applied to a coil terminal and the electric current of the coil into a motor model, thereby calculating magnetic flux, and estimating the rotational position based on the calculated magnetic flux.

### SUMMARY OF THE INVENTION

It is a general object of at least one embodiment of the present invention to provide a position estimation device, a motor drive control device, a position estimation method and a recording medium that substantially obviate one or more problems caused by the limitations and disadvantages of the related art.

In one embodiment, a position estimation device for estimating a position of a rotator of a motor includes an estimation unit configured to estimate a rotational position of the rotator of the motor using a magnetic flux estimation value of the motor, which is calculated by inputting an electric voltage instruction value to be inputted to the motor and a coil electric current value detected from the motor into a motor model in which the motor is identified; and a derivation unit configured to derive a magnetic flux deviation amount due to a distortion of a magnetic flux waveform of the motor according to the rotational position estimated by the estimation unit. The estimation unit corrects the magnetic flux estimation value based on the magnetic flux deviation amount derived by the derivation unit, modifies the estimated rotational position based on the corrected magnetic flux estimation value, and outputs the modified rotational position.

In another embodiment, a motor drive control device includes a position estimation device, which includes an estimation unit configured to estimate a rotational position of the rotator of the motor using a magnetic flux estimation value of the motor, which is calculated by inputting an electric voltage instruction value to be inputted to the motor and a coil electric current value detected from the motor into a motor model in which the motor is identified; and a derivation unit configured to derive a magnetic flux deviation amount due to a distortion of a magnetic flux waveform of the motor according to the rotational position estimated by the estimation unit. The estimation unit corrects the magnetic flux estimation value based on the magnetic flux deviation amount derived by the derivation unit, modifies the estimated rotational position based on the corrected magnetic flux estimation value, and outputs the modified rotational position. The estimation unit estimates a rotational velocity of the rotator of the motor based on the modified rotational position, and outputs the estimated rotational velocity. The rotational velocity of the rotator of the motor is controlled by feeding back the rotational velocity estimated by the estimation unit.

In yet another embodiment, a position estimation method for estimating a position of a rotator of a motor includes estimating a rotational position of the rotator of the motor using a magnetic flux estimation value of the motor, which is calculated by inputting an electric voltage instruction value to be inputted to the motor and a coil electric current value detected from the motor into a motor model in which the motor is identified; deriving a magnetic flux deviation amount due to a distortion of a magnetic flux waveform of the motor according to the estimated rotational position; and correcting the magnetic flux estimation value based on the derived magnetic flux deviation amount, modifying the estimated rotational position based on the corrected magnetic flux estimation value, and outputting the modified rotational position.

In still another embodiment, a non-transitory computer-readable storage medium stores a program for causing a computer of a position estimation device to execute a process of estimating a position of a rotator of a motor. The process includes estimating a rotational position of the rotator of the motor using a magnetic flux estimation value of the motor, which is calculated by inputting an electric voltage instruction value to be inputted to the motor and a coil electric current value detected from the motor into a motor model in which the motor is identified; deriving a magnetic flux deviation amount due to a distortion of a magnetic flux waveform of the motor according to the estimated rotational position; and correcting the magnetic flux estimation value based on the derived magnetic flux deviation amount, modifying the estimated rotational position based on the corrected magnetic flux estimation value, and outputting the modified rotational position.

According to the embodiment of the present application, a rotational position of a rotator of a motor can be estimated with high accuracy.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of a configuration of motor drive control device according to a first embodiment of the present invention;

FIG. 2 is a diagram illustrating an example of a definition of a coordinate system;

FIG. 3 is a diagram for explaining an example of a commutation drive unit according to the first embodiment;

FIG. 4 is a diagram illustrating an example of an upper arm of a drive circuit according to the first embodiment;

FIG. 5 is a diagram for explaining an example of an operation of the commutation drive unit according to the first embodiment;

FIG. 6 is a diagram illustrating an example of a configuration of an electric current detection unit according to the first embodiment;

FIG. 7 is a diagram illustrating an example of a configuration of a magnetic flux estimation unit according to the first embodiment;

FIG. 8 is a diagram illustrating an example of a configuration of a position and velocity estimation unit according to the first embodiment;

FIG. 9 is a diagram for explaining a method of deriving a shift amount of magnetic flux according to the first embodiment;

FIG. 10 is a flowchart illustrating an example of a flow of position and velocity estimation processing by the position and velocity estimation unit according to the first embodiment;

FIG. 11 is a diagram for explaining a method of calculating a shift amount of magnetic flux according to the first embodiment;

FIG. 12 is a diagram illustrating an example of a configuration of a motor drive control device according to a second embodiment of the present invention; and

FIG. 13 is a diagram illustrating an example of a configuration of an induced voltage distortion generation unit according to the second embodiment.

### DESCRIPTION OF THE PREFERRED EMBODIMENTS

In the following, embodiments of the present invention will be described with reference to the accompanying drawings. Meanwhile, upon describing the specification and drawings according to respective embodiments, the same reference numeral is assigned to the component having substantially the same function and configuration, and duplicate explanation will be omitted.

### First Embodiment

### 1. Explanation of a Motor Drive Control Device and a Motor

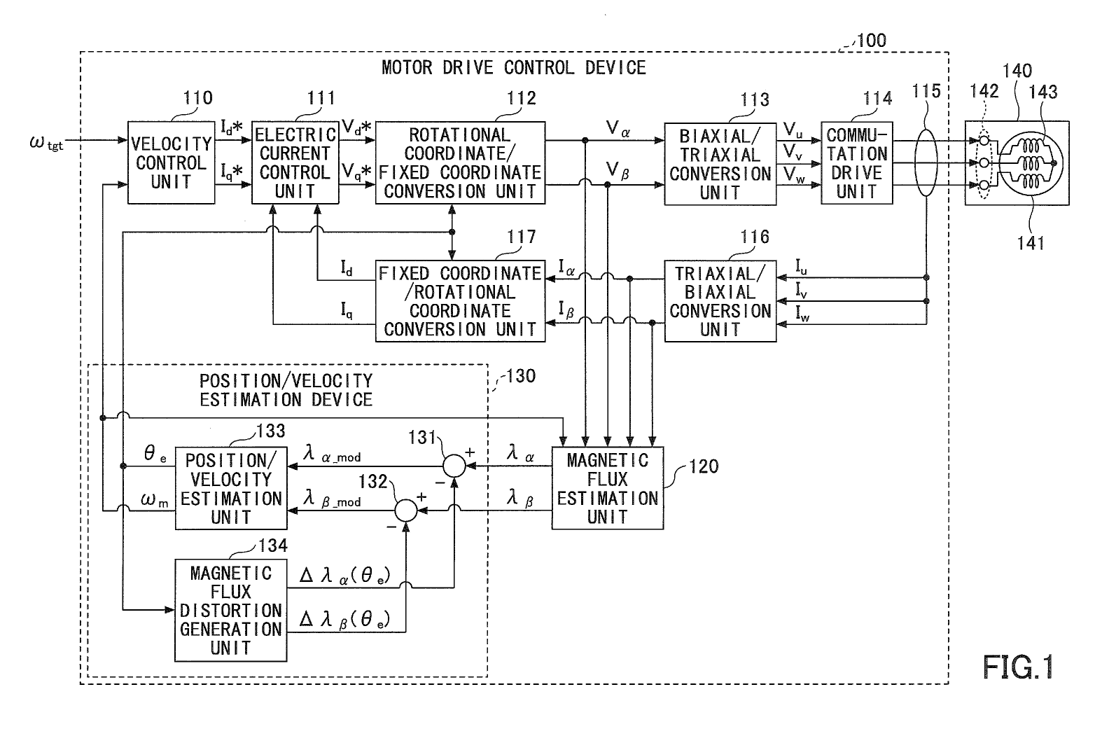

At first, a motor drive control device 100 and a motor 140 driven and controlled by the motor drive control device 100 according to the first embodiment will be explained with reference to FIG. 1. FIG. 1 is a diagram illustrating an example of a configuration of the motor drive control unit 100 according to the first embodiment. Meanwhile, respective components of the motor drive control device 100 may be realized by plural pieces of hardware. Furthermore, a part of or all of them may be realized by causing a computer to execute a program.

As shown in FIG. 1, the motor drive control device 100 includes a velocity control unit 110, an electric current control unit 111, a rotational coordinate/fixed coordinate conversion unit 112, a biaxial/triaxial conversion unit 113, a commutation drive unit 114, an electric current detection unit 115, a triaxial/biaxial conversion unit 116 and a fixed coordinate/rotational coordinate conversion unit 117. Furthermore, the motor drive control device 100 includes a magnetic flux estimation unit 120 and a position/velocity estimation device 130.

The motor 140 driven and controlled by the motor drive control unit 100 is, for example, a brushless motor, which includes a rotator 141, a coil terminal 142 and a coil 143. The coil 143 includes three phases of a U-phase, a V-phase and a W-phase, which have phase differences of 120 degrees from each other and are Y-connected. However, the motor 140 driven and controlled by the motor drive control device 100 is not limited to three phases. Moreover, the motor 140 is not limited to a brushless motor, but may be a stepping motor.

The rotator 141 is arranged at a position which is opposed to the coil 143, and includes a permanent magnet N-poles and S-poles of which are arranged alternately (not shown). The motor 140 rotates by supplying an electric current which is appropriately commutated according to an angle of the rotator 141 from the coil terminal 142 to the coil 143. Meanwhile, in the present embodiment, the permanent magnet of the rotator 141 is assumed to have 2×p poles (a number of pole pairs is p).

The velocity control unit 110 outputs target electric current values I_{d}* and I_{q}* based on a target velocity value of rotational velocity ω_{tgt}, which is input from outside or is preliminarily set, and an estimation value for the rotational velocity ωₘ estimated by the position/velocity estimation device 130.

The electric current control unit 111 includes proportional integral control units (not shown) for a d-axis and a q-axis, respectively. The proportional integral control units generate electric voltage instruction values V_{d}* and V_{q}*, which are instruction values of electric voltages to be applied to the d-axis and the q-axis, respectively, from the target electric current values I_{d}* and I_{q}* of the d-axis and the q-axis and detected coil electric current values I_{d} and I_{q}. That is, the electric voltage instruction values V_{d}* and V_{q}* are control signals that control the electric current supplied to the coil 143 in order to drive the rotation of the motor 140.

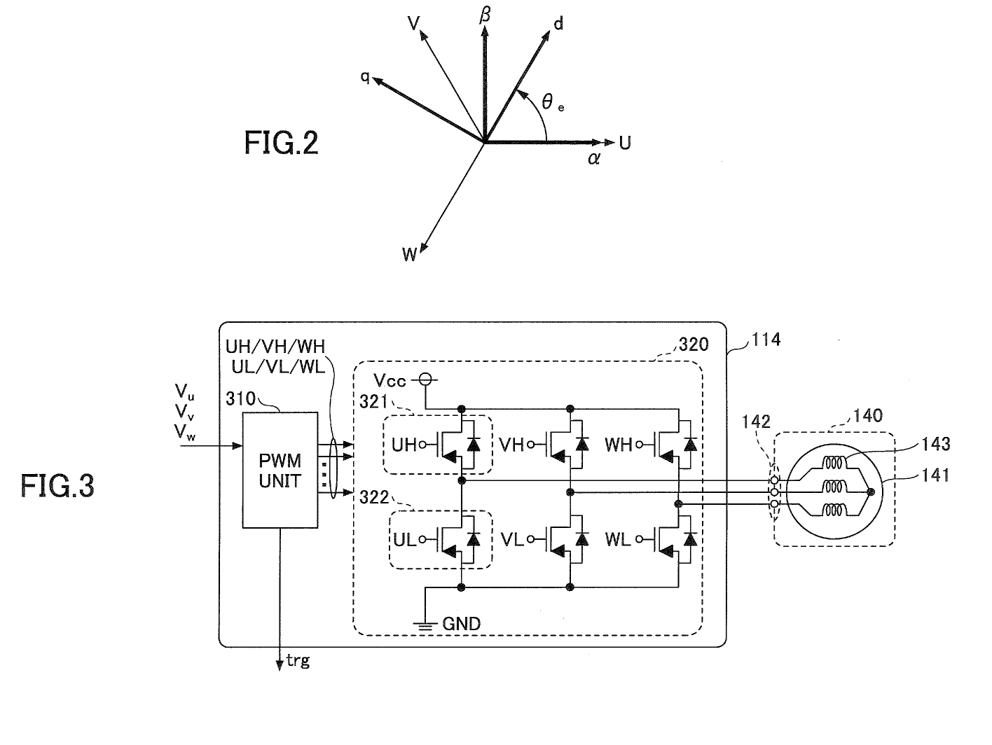

The rotational coordinate/fixed coordinate conversion unit 112 inputs the electric voltage instruction values V_{d}* and V_{q}* outputted from the electric current control unit 111, performs a coordinate conversion from a dq rotational coordinate system, shown in FIG. 2, to an αβ fixed coordinate system, and outputs electric voltage instruction values V_{α} and V_{β} in the αβ fixed coordinate system. Meanwhile, FIG. 2 is a diagram illustrating an example of a definition of the coordinate systems, and illustrates a relation among UVW coordinate axes, the αβ fixed coordinate axes and the dq rotational coordinate axes.

The rotational coordinate/fixed coordinate conversion unit 112 performs the coordinate conversion from the dq rotational system to the αβ fixed coordinate system by using a coordinate conversion arithmetic expression shown by (formula 1) as follows:

$$\begin{matrix}[ equation 1 ] & \\ [ \begin{matrix}{V}_{α} \\ {V}_{β}\end{matrix} ] = [ \begin{matrix}cos {θ}_{e} & - sin {θ}_{e} \\ sin {θ}_{e} & cos {θ}_{e}\end{matrix} ] [ \begin{matrix}{V}_{d} \\ {V}_{q}\end{matrix} ] & ( formula 1 )\end{matrix}$$

The biaxial/triaxial conversion unit 113 inputs the electric voltage instruction values V_{α} and V_{β} outputted from the rotational coordinate/fixed coordinate conversion unit 112, performs the coordinate conversion from the αβ fixed coordinate system to the UVW coordinate system, as shown in FIG. 2, and outputs phase electric voltage instruction values Vᵤ, Vᵥ and V_{w}. The phase electric voltage instruction values Vᵤ, Vᵥ and V_{w} are electric voltage values to be applied to the coil terminals 142 of the U-phase, V-phase and W-phase, respectively.

The biaxial/triaxial conversion unit 113 performs the coordinate conversion from the αβ coordinate system to the UVW coordinate system by using a coordinate conversion arithmetic expression shown by (formula 2) as follows:

$$\begin{matrix}[ equation 2 ] & \\ [ \begin{matrix}{V}_{U} \\ {V}_{V} \\ {V}_{W}\end{matrix} ] = \sqrt{\frac{2}{3}} [ \begin{matrix}1 & 0 \\ - 1 / 2 & \sqrt{3} / 2 \\ - 1 / 2 & - \sqrt{3} / 2\end{matrix} ] [ \begin{matrix}{V}_{α} \\ {V}_{β}\end{matrix} ] & ( formula 2 )\end{matrix}$$

The commutation drive unit 114 applies pulse modulated electric voltage to the coil terminals 142 of the motor 140 based on the phase electric voltage instruction values Vᵤ, Vᵥ and V_{w}.

The electric current detection unit 115 detects, from the coil electric current flowing in the coil 143, coil electric current values Iᵤ, Iᵥ and I_{w} of coil electric current flowing in the U-phase and the V-phase and the W-phase coils, and outputs them.

The triaxial/biaxial conversion unit 116 inputs the coil electric current values Iᵤ, Iᵥ and I_{w} outputted from the electric current detection unit 115, performs the coordinated conversion from the UVW coordinate system, as shown in FIG. 2, to the αβ fixed coordinate system and outputs coil electric current values I_{α} and I_{β}. The triaxial/biaxial conversion unit 116 performs the coordinate conversion from the UVW coordinate system to the αβ fixed coordinate system by using a coordinate conversion arithmetic expression shown by (formula 3) as follows:

$$\begin{matrix}[ equation 3 ] & \\ [ \begin{matrix}{I}_{α} \\ {I}_{β}\end{matrix} ] = \sqrt{\frac{2}{3}} [ \begin{matrix}1 & - 1 / 2 & - 1 / 2 \\ 0 & \sqrt{3} / 2 & - \sqrt{3} / 2\end{matrix} ] [ \begin{matrix}{I}_{U} \\ {I}_{V} \\ {I}_{W}\end{matrix} ] & ( formula 3 )\end{matrix}$$

The fixed coordinate/rotational coordinate conversion unit 117 inputs the coil electric current values I_{α} and I_{β} outputted from the triaxial/biaxial conversion unit 116, performs coordinate conversion from the αβ fixed coordinate system, as shown in FIG. 2, to the dq rotational coordinate system and outputs the coil electric current values I_{d} and I_{q}. The fixed coordinate/rotational coordinate conversion unit 117 performs the coordinate conversion from the αβ fixed coordinate system to the dq rotational coordinate system by using a coordinate conversion arithmetic expression shown by (formula 4) as follows:

$$\begin{matrix}[ equation 4 ] & \\ [ \begin{matrix}{I}_{d} \\ {I}_{q}\end{matrix} ] = [ \begin{matrix}cos {θ}_{e} & sin {θ}_{e} \\ - sin {θ}_{e} & cos {θ}_{e}\end{matrix} ] [ \begin{matrix}{I}_{α} \\ {I}_{β}\end{matrix} ] & ( formula 4 )\end{matrix}$$

The coil electric current values I_{α} and I_{β} outputted from the fixed coordinate/rotational coordinate conversion unit 117 are inputted to the electric current control unit 111.

The magnetic flux estimation unit 120 inputs the electric voltage instruction values V_{α} and V_{β} outputted from the rotational coordinate/fixed coordinate conversion unit 112, the coil electric current value I_{α} and I_{β} outputted from the triaxial/biaxial conversion unit 116 and estimated value of the rotational velocity ωₘ of the rotator 141 outputted from the position/velocity estimation device 130. The magnetic flux estimation unit 120 outputs magnetic flux estimation values λ_{α} and λ_{β} in the αβ fixed coordinate system based on the inputted values.

The position/velocity estimation device 130 inputs the magnetic flux estimation values λ_{α} and λ_{β} outputted from the magnetic flux estimation unit 120, corrects distortion of a waveform of the magnetic flux, and calculates an estimation value of a rotational position θₑ of the rotator 141 and an estimation value of a rotational velocity ωₘ. Moreover, the position/velocity estimation device 130 outputs the calculated estimation value of the rotational position θₑ to the rotational coordinate/fixed coordinate conversion unit 112 and the fixed coordinate/rotational coordinate conversion unit 117. Furthermore, the position/velocity estimation device 130 outputs the calculated estimation value of the rotational velocity ωₘ to the velocity control unit 110 and the magnetic flux estimation unit 120.

As shown in FIG. 1, the position/velocity estimation device 130 includes subtraction units 131 and 132, a position/velocity estimation unit 133 and a magnetic flux distortion generation unit 134. By the respective components operating associated with each other, the position/velocity estimation is performed. The subtraction units 131 and 132 subtract magnetic flux deviation amounts Δλ_{α}(θₑ) and Δλ_{β}(θₑ) outputted from the magnetic flux distortion generation unit 134 from the magnetic flux estimation value λ_{α} and λ_{β} outputted from the magnetic flux estimation unit 120, respectively, and output magnetic flux estimation values λ_{α}_{_{—}}_{mod} and λ_{β}_{_{—}}_{mod}, in which distortion of the magnetic flux waveform is corrected.

The magnetic flux distortion generation unit 134 inputs the estimation value of the rotational position θₑ calculated based on the magnetic flux estimation values λ_{α} and λ_{β} in the position/velocity estimation unit 133, and outputs magnetic flux deviation amounts Δλ_{α}(θₑ) and Δλ_{β}(θₑ) in response to the inputted estimation value of the rotational position θₑ.

The position/velocity estimation unit 133 calculates the estimation value of the rotational position θₑ of the rotator 141 and the estimation value of the rotational velocity ωₘ based on the magnetic flux estimation value λ_{α}_{_{—}}_{mod} and λ_{β}_{_{—}}_{mod} in which the distortion of the magnetic flux waveform is corrected and which are outputted from the subtraction units 131 and 132. Moreover, the calculated estimation value θₑ of the rotational position is outputted to the rotational coordinate/fixed coordinate conversion unit 112, the fixed coordinate/rotational coordinate conversion unit 117 and the magnetic flux distortion generation unit 134. Moreover, calculated estimation value of the rotational velocity ωₘ is outputted to the velocity control unit 110 and to the magnetic flux estimation unit 120. By outputting the estimation value of the rotational velocity ωₘ to the velocity control unit 110, a feedback control of the rotational velocity of the motor 140 is made possible in the velocity control unit 110.

In the following, among the respective components of the above-described motor drive control device 100, the commutation drive unit 114, the electric current detection unit 115, the magnetic flux estimation unit 120 and the position/velocity estimation device 130 will be explained in more detail.

### 2. Details of the Commutation Drive Unit

First, details of the commutation drive unit 114 will be explained with reference to FIGS. 3 to 5. FIG. 3 is a diagram for explaining the commutation drive unit 114.

As shown in FIG. 3, the commutation drive unit 114 includes a PWM (pulse width modulation) unit 310 and a drive circuit 320. The PWM unit 310 performs a pulse-width modulation for the phase electric voltage instruction values Vᵤ, Vᵥ and V_{w}, and generates gate signals of three phases UH, VH, WH, UL, VL and WL. The gate signals UH, VH, WH, UL, VL and WL are supplied to the drive circuit 320.

The drive circuit 320 comprises an upper arm 321 and a lower arm 322 which are connected to each other in three phases. In the drive circuit 320, ON/OFF of switching elements, with which the upper arm 321 and the lower arm 322 are provided, are controlled by the gate signals (UH, VH, WH, UL, VL and WL). The drive circuit 320 drives the rotation of the rotor 141 by applying the electric voltage, for which the pulse width modulation is performed, to the coil terminals 142 and supplying an electric current to the coil 143.

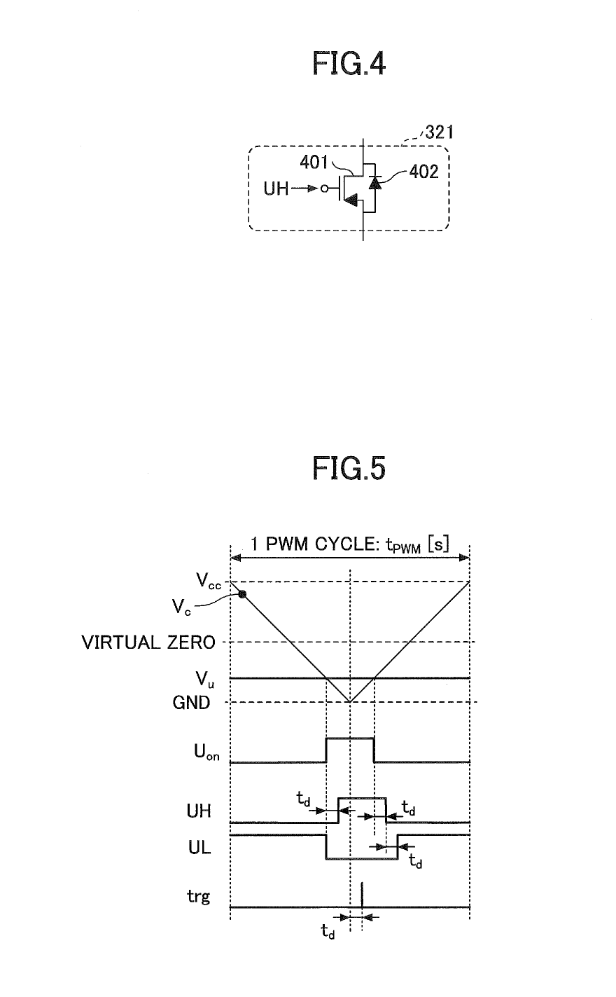

FIG. 4 is a diagram illustrating an example of the upper arm 321 of the drive circuit 320 according to the present embodiment. In the drive circuit 320, the upper arm 321 includes a switching element 401 connected to a power supply voltage Vcc and a diode 402, which are connected in parallel. Moreover, the lower arm 322 according to the present embodiment has the same configuration as the upper arm 321 and is connected to ground (GND).

FIG. 5 is a diagram for explaining an operation of the commutation drive unit 114. Meanwhile, since the U-phase, the V-phase and the W-phase have the same configuration and the same operations, in FIG. 5 only the U-phase will be explained.

In FIG. 5, a carrier wave V_{c}, shown in the first step, is assumed to be a triangular wave with a predetermined cycle t_{PWM} of a PWM signal and have an amplitude from ground GND to the power supply voltage V_{cc}. In the following, the cycle of the PWM signal will be referred to as a PWM cycle.

The PWM unit 310 assumes a central value between the power supply voltage V_{cc} and ground GND in the carrier wave V_{c} to be virtual zero, compares the electric voltage instruction value Vᵤ to the carrier wave V_{c} in magnitude, and generates a PWM signal Uₒₙ, shown in the second step. Meanwhile, the electric voltage instruction value Vᵤ changes its value at the beginning of the PWM cycle.

Next, the PWM unit 310 generates a gate signal UH of a switching element 401 of the upper arm 321, which is a signal delayed from the PWM signal Uₒₙ by t_{d}, as shown in the third and fourth steps. Moreover, the PWM unit 310 generates a gate signal UL of a switching element of the lower arm 322, which is a signal obtained by inverting the PWM signal Uₒₙ and by delaying a rising edge (a trailing edge in Uₒₙ) by twice the period t_{d}. Meanwhile, the period t_{d} is a short circuit prevention section (dead time) provided in order to prevent short circuit between the switching elements of the upper arm 321 and of the lower arm 322.

Moreover, the PWM unit 310 outputs a trigger trg, which is a pulse signal, to the electric current detection unit 115 at timing delayed from a center of the PWM cycle by the period t_{d}. This delay is adjusted to the generation of the gate signals (UH and UL), which are delayed from the carrier wave V_{c} by the period t_{d}.

### 3. Details of the Electric Current Detection Unit

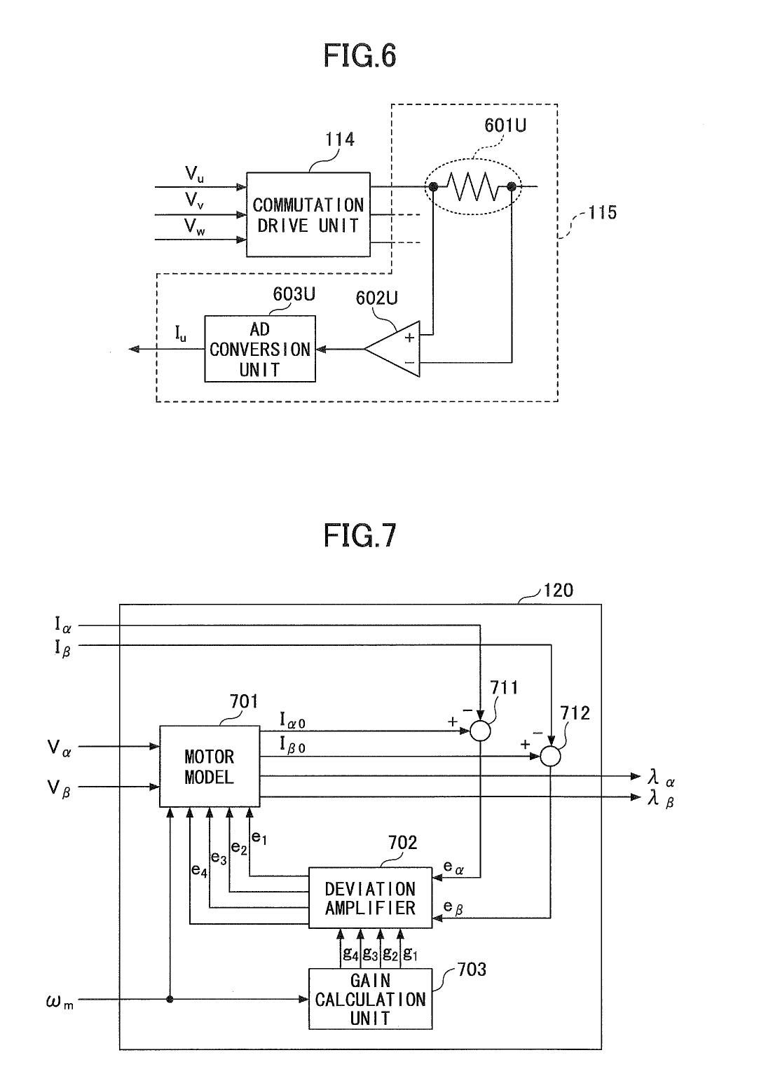

Next, details of the electric current detection unit 115 will be explained with reference to FIG. 6. FIG. 6 is a diagram illustrating a configuration of the electric current detection unit 115 according to the present embodiment. Meanwhile, since the electric current detection unit 115 includes the same configuration for at least two phases of the U-phase, the V-phase and the W-phase, in FIG. 6, only the U-phase will be explained.

The electric current detection unit 115 includes a shunt resister 601U, a difference amplifier 602U and an AD conversion unit 603U. The shunt resister 601U is a resister inserted on a coil electric current path between the coil terminal 142 and the commutation drive unit 114.

The difference amplifier 602U has an inverting input terminal and non-inverting input terminal connected to respective ends of the shunt resister 601U. A voltage drop generated by the shunt resister 601U proportional to a magnitude of the electric current is detected, amplified at a predetermined magnification and outputted. In the present embodiment, the output from the AD conversion unit 603U is referred to as a coil electric current value Iᵤ.

The predetermined magnification is set so that an output from the differential amplifier 602U is within a full scale range of an input of the AD conversion unit 603U, based on amplitude of the coil electric current assumed from an operation condition of the motor 140 and on a resistance value of the shunt resister 601U.

The AD conversion unit 603U converts a value sampled at each cycle from the outputs of the difference amplifier 602U into a digital value in which the smallest unit is a predetermined quantization resolution, and outputs it as a coil electric current value. Meanwhile, the quantization resolution [V/LSB] is a value obtained by dividing an electric voltage width [V] of an input full scale, which is a hardware specification of the AD conversion unit 603U, by a data resolution [LSB].

### 4. Details of the Magnetic Flux Estimation Unit

Next, details of the magnetic flux estimation unit 120 will be explained with reference to FIG. 7. FIG. 7 is a diagram illustrating a configuration of the magnetic flux estimation unit 120. As shown in FIG. 7, the magnetic flux estimation unit 120 includes a motor model 701, a deviation amplifier 702, a gain calculation unit 703 and calculation units 711 and 712.

The motor model 701 is a model which identifies the motor 140, and outputs electric current estimation values I_{αO} and I_{βO} in the αβ fixed coordinate system and magnetic flux estimation values λ_{α} and λ_{β} based on the electric voltage instruction value V_{α} and V_{β}, the estimation value ωₘ for the rotational velocity, and deviations e₁, e₂, e₃ and e₄.

The motor model 701 calculates the electric current estimation values I_{αO} and I_{βO} in the αβ fixed coordinate system and the magnetic flux estimation values λ_{α} and λ_{β} by using the following formula (formula 5). Meanwhile, R represents a winding resistance value of the coil 143 and L represents an inductance of the coil 143.

$$\begin{matrix}[ equation 5 ] & \\ \frac{d}{d t} ( \begin{matrix}{I}_{α} \\ {I}_{β} \\ {λ}_{α} \\ {λ}_{β}\end{matrix} ) = [ \begin{matrix}- R / L & 0 & 0 & {θ}_{e} / L \\ 0 & - R / L & - {θ}_{e} / L & 0 \\ 0 & 0 & 0 & - {θ}_{e} \\ 0 & 0 & {θ}_{e} & 0\end{matrix} ] [ \begin{matrix}{I}_{α} \\ {I}_{β} \\ {λ}_{α} \\ {λ}_{β}\end{matrix} ] + [ \begin{matrix}1 / L & 0 \\ 0 & 1 / L \\ 0 & 0 \\ 0 & 0\end{matrix} ] [ \begin{matrix}{V}_{α} \\ {V}_{β}\end{matrix} ] - [ \begin{matrix}{e}_{1} \\ {e}_{2} \\ {e}_{3} \\ {e}_{4}\end{matrix} ] & ( formula 5 )\end{matrix}$$

The subtraction unit 711 outputs a result obtained by subtracting the coil electric current value I_{α} from the electric current estimation value I_{αO} as the electric current deviation e_{α}. Similarly, the subtraction unit 712 outputs a result obtained by subtracting the coil electric current value I_{β} from the electric current estimation value I_{αO} as the electric current deviation e_{β}.

The gain calculation unit 703 outputs gains g₁, g₂, g₃ and g₄ based on the estimation value ωₘ for the rotational velocity outputted from the position/velocity estimation device 130 by using the following formula (formula 6). Meanwhile, k is an arbitrary real number greater than 1.

$$\begin{matrix}[ equation 6 ] & \\ \begin{matrix}{g}_{1} = - ( k - 1 ) \frac{R}{L} \\ {g}_{2} = ( k - 1 ) {θ}_{e} \\ {g}_{3} = kR \\ {g}_{4} = - kL {θ}_{e}\end{matrix} \} & ( formula 6 )\end{matrix}$$

The deviation amplifier 702 amplifies the electric current deviations e_{α} and e_{β} by the gains g₁, g₂, g₃ and g₄, and outputs deviations e₁, e₂, e₃ and e₄. Specifically, the deviation amplifier 702 calculates the deviations e₁, e₂, e₃ and e₄ by using the following formula (formula 7), and outputs them to the motor model 701.

$$\begin{matrix}[ equation 7 ] & \\ [ \begin{matrix}{e}_{1} \\ {e}_{2} \\ {e}_{3} \\ {e}_{4}\end{matrix} ] [ \begin{matrix}{g}_{1} & - {g}_{2} \\ {g}_{2} & {g}_{1} \\ {g}_{3} & - {g}_{4} \\ {g}_{4} & {g}_{3}\end{matrix} ] [ \begin{matrix}{e}_{α} \\ {e}_{β}\end{matrix} ] & ( formula 7 )\end{matrix}$$

### 5. Details of the Position/Velocity Estimation Device

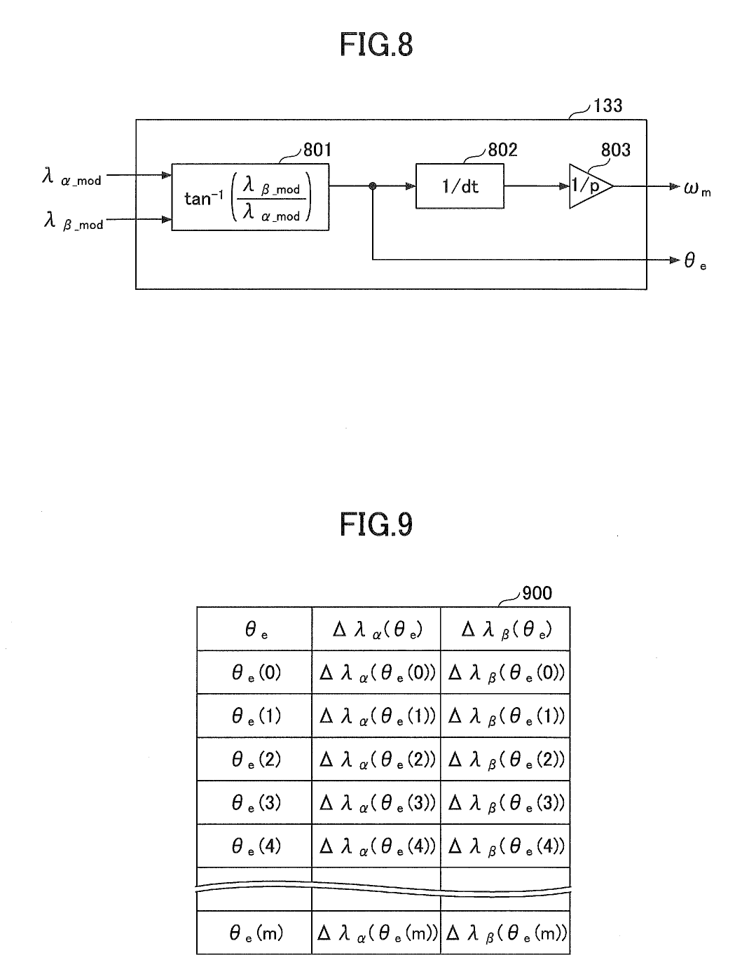

Next, details of the position/velocity estimation device 130 will be explained with reference to FIGS. 8 to 10. At first, a position/velocity estimation unit 133 will be explained. FIG. 8 is a diagram illustrating a configuration of the position/velocity estimation unit 133 included in the position/velocity estimation device 130.

As shown in FIG. 8, the position/velocity estimation unit 133 includes a position estimation unit 801, a differentiator 802 and an amplifier 803.

The position estimation unit 801 calculates the estimation value of the rotational position θₑ of the rotator 141 based on the magnetic flux estimation values λ_{α}_{_{—}}_{mod} and λ_{β}_{_{—}}_{mod} in which the distortion of the magnetic flux waveform is corrected and which are outputted from the subtraction units 131 and 132. Specifically, in the position estimation unit 801, the estimation value of the rotational position θₑ is calculated by using the following formula (formula 8).

$$\begin{matrix}[ equation 8 ] & \\ {θ}_{e} = {tan}^{- 1} ( \frac{{λ}_{β\_ mod}}{{λ}_{α\_ mod}} ) & ( formula 8 )\end{matrix}$$

Meanwhile, the magnetic flux estimation values λ_{α}_{_{—}}_{mod} and λ_{β}_{_{—}}_{mod} are λ_{α} and λ_{β}, respectively, in the case where the magnetic flux deviation amounts Δλ_{α}(θₑ) and Δλ_{β}(θₑ) are “0”.

The differentiator 802 differentiates the estimation value θₑ of the rotational position of the rotator 141, which is outputted from the position estimation unit 801. The amplifier 803 calculates the estimation value of the rotational velocity ωₘ by multiplying the differentiated estimation value θₑ by 1/p. Meanwhile, p represents a number of pole pairs of the motor 140.

Next, the magnetic flux distortion generation unit 134 will be explained. FIG. 9 is a database included in the magnetic flux distortion generation unit which configures the position/velocity estimation device 130. As shown in FIG. 9, the magnetic flux distortion generation unit 134 stores, for example, magnetic flux deviation amounts (differences between ideal waveforms of magnetic flux and actual waveforms of magnetic flux) at respective rotational positions of the rotator 141, which are measured upon adjustment before factory shipping of the motor 140, as a database 900 in a built-in storage element.

Furthermore, in the magnetic flux distortion generation unit 134, upon the estimation value of the rotational position θₑ being inputted by the position/velocity estimation unit 133, the database 900 stored in the built-in storage element is referred to. According to the above-described operation, in the magnetic flux distortion generation unit 134 magnetic flux deviation amounts Δλ_{α}(θₑ) and Δλ_{β}(θₑ) associated with the inputted estimation value of the rotational position θₑ can be outputted.

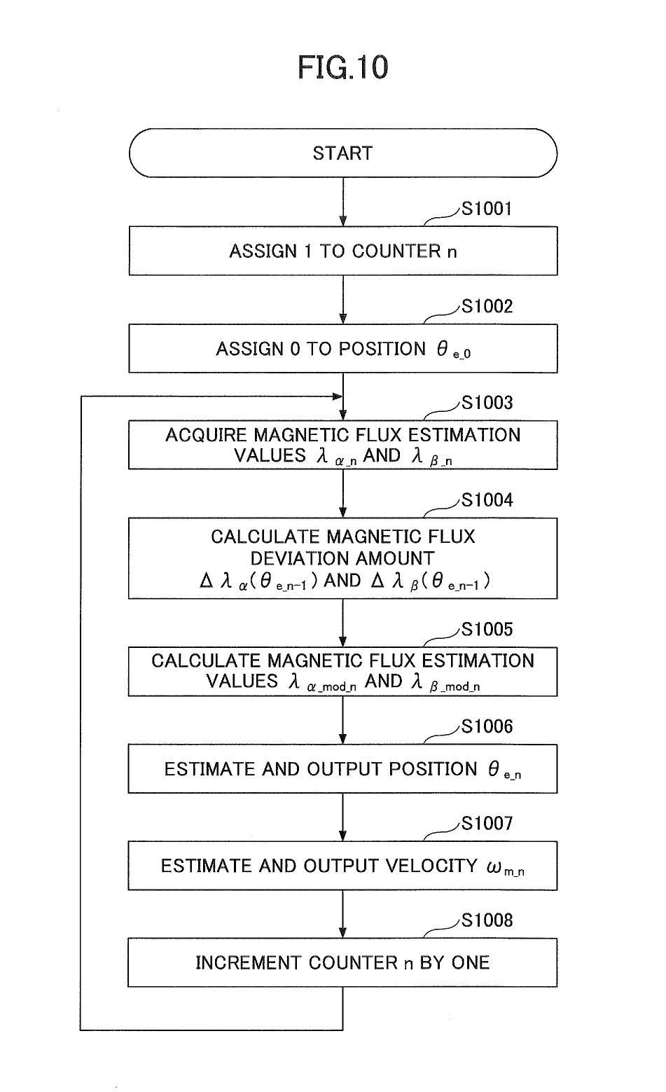

Subsequently, a flow of position/velocity estimation processing executed by closely-linked operations of the respective components of the position/velocity estimation device 130 will be explained with reference to FIG. 10. FIG. 10 is a flowchart illustrating a flow of the position/velocity estimation processing by the position/velocity estimation device 130.

At first, the position/velocity estimation unit 133 assigns a value “1” to a counter n (step S1001). The counter n counts a number of outputs of the magnetic flux estimation values λ_{α} and λ_{β} from the magnetic flux estimation unit 120, and a number of calculations of the estimation value of the rotational position θₑ and the estimation value of the rotational velocity ωₘ in the position/velocity estimation unit 133.

The position/velocity estimation unit 133 assigns a value “0” to an initial value of the estimation value of the rotational position θₑ_{_{—}}₀ (step S1002).

The subtraction units 131 and 132 acquire the magnetic flux estimation values λ_{α}_{_{—}}ₙ and λ_{β}_{_{—}}ₙ from the magnetic flux estimation unit 120 (step S1003).

In the magnetic flux distortion generation unit 134, magnetic flux deviation amount Δλ_{α}(θₑ_{_{—}}ₙ₋₁) and Δλ_{β}(θₑ_{_{—}}ₙ₋₁) are calculated based on the estimation value of the rotational position θₑ_{_{—}}ₙ₋₁ outputted from the position/velocity estimation unit 133 (step S1004). In the magnetic flux distortion generation unit 134, the calculated magnetic flux deviation amounts Δλ_{α}(θₑ_{_{—}}ₙ₋₁) and Δλ_{β}(θₑ_{_{—}}ₙ₋₁) are outputted to the subtraction units 131 and 132.

In the subtraction units 131 and 132, the magnetic flux deviation amounts Δλ_{α}(θₑ_{_{—}}ₙ₋₁) and Δλ_{β}(θₑ_{_{—}}ₙ₋₁) are respectively subtracted from the magnetic flux estimation values λ_{α}_{_{—}}ₙ and λ_{β}_{_{—}}ₙ obtained at step S1003 (step S1005). Then, magnetic flux estimation values λ_{α}_{_{—}}_{mod}_{_{—}}ₙ and λ_{β}_{_{—}}_{mod}_{_{—}}ₙ in which distortion of magnetic flux waveform is corrected, are calculated. In the subtraction units 131 and 132, the calculated magnetic flux estimation values λ_{α}_{_{—}}_{mod}_{_{—}}ₙ and λ_{β}_{_{—}}_{mod}_{_{—}}ₙ are outputted to the position/velocity estimation unit 133.

The position/velocity estimation unit 133 calculates the estimation value of the rotational position θₑ_{_{—}}ₙ based on the magnetic flux estimation values λ_{α}_{_{—}}_{mod}_{_{—}}ₙ and λ_{β}_{_{—}}_{mod}_{_{—}}ₙ outputted from the subtraction units 131 and 132 (step S1006). In the position/velocity estimation unit 133, the calculated estimation value of the rotational position θₑ_{_{—}}ₙ (corrected estimation value) is outputted to the rotational coordinate/fixed coordinate conversion unit 112 and the fixed coordinate/rotational coordinate conversion unit 117. Furthermore, in the position/velocity estimation unit 133, the calculated estimation value of the rotational position θₑ_{_{—}}ₙ is outputted to the magnetic flux distortion generation unit 134 and is used for correction of the next magnetic flux estimation value.

The position/velocity estimation unit 133 calculates the estimation value of the rotational velocity ωₘ_{_{—}}ₙ based on the estimation value of the rotational position θₑ_{_{—}}ₙ calculated at step S1006, and outputs it to the velocity control unit 110 and the magnetic flux estimation unit 120 (step S1007). Afterwards, the process proceeds to step S1008, the counter n is incremented, and the process returns to step S1003. Then, the next magnetic flux estimation values λ_{α}_{_{—}}ₙ and λ_{β}_{_{—}}ₙ are acquired from the magnetic flux estimation unit 120, and the same processes as above are performed.

### 6. Summary

As is clear from the above explanations, in the motor drive control device according to the present embodiment, a magnetic flux deviation amount due to distortion of a magnetic flux waveform is subtracted from a magnetic flux estimation value upon the position/velocity estimation device calculating an estimation value of the rotational position of a rotator based on a magnetic flux estimation value outputted from a magnetic flux estimation unit.

Furthermore, in the motor drive control device according to the present embodiment, a magnetic flux deviation amount associated with a calculation result of an estimation value of rotational position is derived by preliminarily measuring magnetic flux deviation amounts due to distortion of a magnetic flux waveform at respective rotational positions of the rotator and by storing them in a storage element of the position/velocity estimation device as a database.

Actual motors include manufacturing errors or the like. Even if a rotator including permanent magnets is rotated at a constant velocity, a change of interlinkage magnetic flux of a rotator winding (magnetic flux waveform) does not take a form of an ideal sine waveform, but a distorted waveform.

For this reason, in the case of the method of calculating magnetic flux by using the motor model and estimating a rotational position based on the calculated magnetic flux, as disclosed in Japanese Published Patent Application No. 2012-244735, an error occurs in an estimated value.

According to the above-described configurations of the present embodiment, even in a case where the magnetic flux waveform of the motor during rotation includes distortion, a rotational position of the rotator can be estimated with high accuracy. Moreover, a rotational velocity which is calculated based on the rotational position of the rotator can be estimated with high accuracy.

### Second Embodiment

In the above-described first embodiment, magnetic flux deviation amounts at respective rotational positions of the rotator are measured preliminarily, and are stored in the storage element as a database. The present invention is not limited to the above configuration. For example, the magnetic flux deviation amount may be approximated as a harmonic component of an ideal magnetic flux waveform, and a high-order expression representing the harmonic component of magnetic flux waveform may be stored in the storage element.

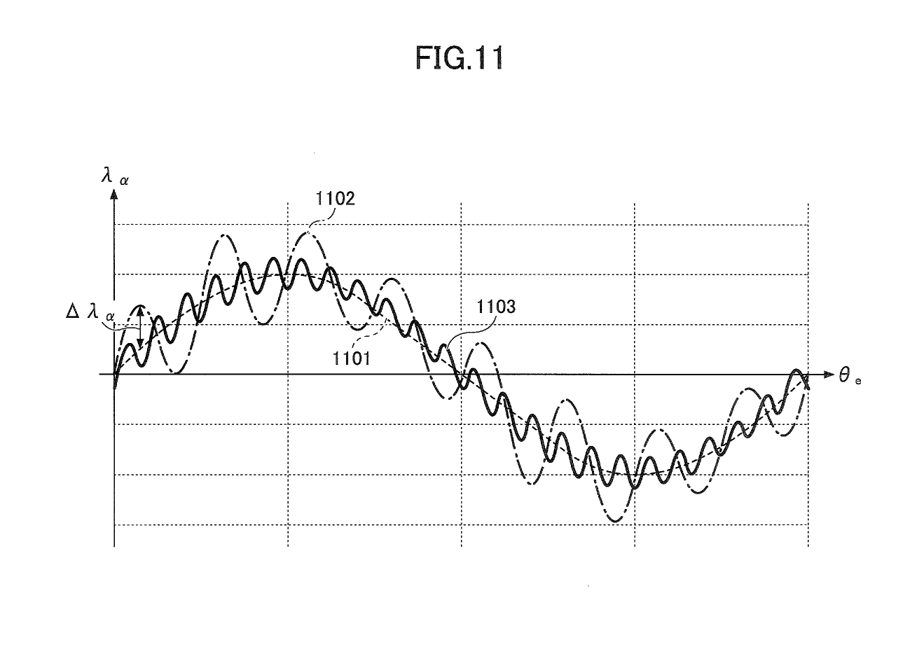

FIG. 11 is a diagram illustrating harmonic components of an ideal magnetic flux waveform (dashed curve 1101). In the example shown in FIG. 11, two kinds of harmonic components having different frequencies (harmonic component shown by dot-dashed curve 1102 and harmonic component shown by solid curve 1103) are shown.

By using a high-order expression representing the harmonic components shown in FIG. 11, in the magnetic flux distortion generation unit 134, a magnetic flux deviation amount (difference from the ideal magnetic waveform (dashed curve 1101), i.e. a magnetic flux deviation amount Δλ_{α} in the example of FIG. 11) can be calculated based on a estimation value of rotational position θₑ outputted from the position/velocity estimation unit 133.

### Third Embodiment

In the above-described first and second embodiments, a magnetic flux deviation amount outputted from the magnetic flux distortion generation unit 134 is used for calculation of estimation values of rotational position and rotational velocity of the rotator 141. However, the present invention is not limited to them. For example, an induced voltage deviation amount may be calculated based on distortion of induced voltage and may be added to an electric voltage instruction value.

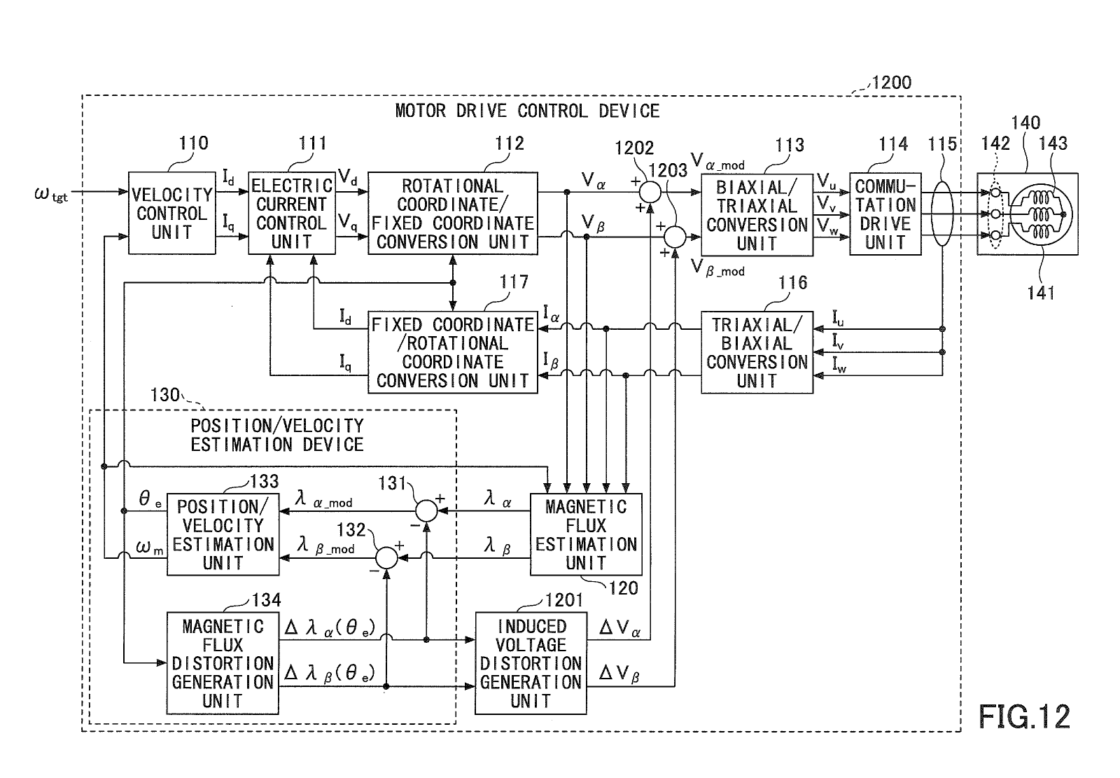

FIG. 12 is a diagram illustrating a configuration of a motor drive control device 1200 according to the third embodiment. Meanwhile, to the same component as that in the motor drive control device 100 shown in FIG. 1, the same reference numeral is assigned, and its explanation will be omitted. Difference from the motor drive control device 100 shown in FIG. 1 is that an induced voltage distortion generation unit 1201 and addition units 1202 and 1203 are added.

The induced voltage distortion generation unit 1201 acquires magnetic flux deviation amounts Δλ_{α}(θₑ) and Δλ_{β}(θₑ) and performs differential process for the acquired magnetic flux deviation amounts Δλ_{α}(θₑ) and Δλ_{β}(θₑ), and thereby calculates respective induced voltage deviation amounts ΔV_{α} and ΔV_{β}.

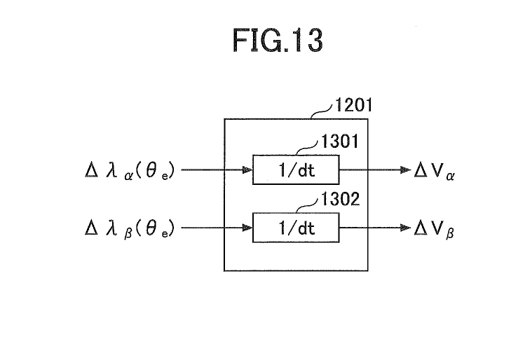

FIG. 13 is a diagram illustrating a configuration of the induced voltage distortion generation unit 1201. As shown in FIG. 13, the induced voltage distortion generation unit 1201 includes differentiators 1301 and 1302. The differentiator 1301 performs differential process for the magnetic flux deviation amount Δλ_{α}(θₑ) outputted from the magnetic flux distortion generation unit 134, thereby outputs an induced voltage deviation amount ΔV_{α}. Moreover, the differentiator 1302 performs differential process for the magnetic flux deviation amount Δλ_{β}(θₑ) outputted from the magnetic flux distortion generation unit 134, thereby outputs an induced voltage deviation amount ΔV_{β}.

Returning to the explanation for FIG. 12, the addition unit 1202 adds the induced voltage deviation amount ΔV_{α} outputted from the induced voltage distortion generation unit 1201 to an electric voltage instruction value V_{α} outputted from the rotational coordinate/fixed coordinate conversion unit 112, and thereby corrects the electric voltage instruction value V_{α}. Then, the addition unit 1202 outputs the corrected electric voltage instruction value V_{α}_{_{—}}_{mod} to the biaxial/triaxial conversion unit 113. In the same way, the addition unit 1203 adds the induced voltage deviation amount ΔV_{β} outputted from the induced voltage distortion generation unit 1201 to an electric voltage instruction value V_{β} outputted from the rotational coordinate/fixed coordinate conversion unit 112, and thereby corrects the electric voltage instruction value V_{β}. Then, the addition unit 1203 outputs the corrected electric voltage instruction value V_{β}_{_{—}}_{mod} to the biaxial/triaxial conversion unit 113.

In this way, in the motor drive control device 1200 according to the present embodiment, in addition to the configuration of the above-described first or second embodiment, an induced voltage deviation amount based on distortion of induced electric voltage is calculated based on a calculated magnetic flux deviation amount, and is added to an electric voltage instruction value.

According to the above-described configuration, even in a case where a magnetic flux waveform of a motor during rotation includes distortion, a rotational position and a rotational velocity of a rotator can be estimated with high accuracy. Additionally, torque variation, which occurs under influence of distortion of induced electric voltage, can be suppressed.

### Fourth Embodiment

In the above-described first to third embodiments, the magnetic flux estimation unit 120 is arranged in the motor drive control device, and magnetic flux estimation values λ_{α} and λ_{β} outputted from the magnetic flux estimation unit 120 are corrected based on a magnetic flux deviation amount. However, the present invention is not limited to this.

For example, an induced voltage estimation unit may be arranged instead of the magnetic flux estimation unit 120, and induced voltage estimation values IV_{α} and IV_{β} outputted from the induced voltage estimation unit may be corrected based on the include voltage deviation amounts ΔIV_{α}(θₑ) and ΔIV_{β}(θₑ).

In general, in the case where magnetic flux waveform includes distortion, induced voltage also has a waveform which is distorted from an ideal sine waveform. For this reason, for example, by measuring an induced voltage deviation amount (difference between ideal induced voltage waveform and actual induced voltage waveform) at each rotational position of the rotator 141, and storing the deviation amount in a storage element as database, induced voltage deviation amount can be derived.

Moreover, in the above-described first to third embodiments, an estimation value of rotational velocity is calculated based on an estimation value of rotational position so as to feed back to the velocity control unit. However, in the case of a motor drive control device which does not perform velocity feed back, it is not necessary to calculate case, the position/velocity estimation unit 133 only calculates an estimation value of rotational position, and the position/velocity estimation device 130 functions as a position estimation device.

Further, the present invention is not limited to these embodiments, but various variations and modifications may be made without departing from the scope of the present invention.

The present application is based on and claims the benefit of priority of Japanese Priority Application No. 2014-175129 filed on Aug. 29, 2014, the entire contents of which are hereby incorporated by reference.

What is claimed is:

1. A position estimation device for estimating a position of a rotator of a motor comprising:
an estimation unit configured to estimate a rotational position of the rotator of the motor using a magnetic flux estimation value of the motor, which is calculated by inputting an electric voltage instruction value to be inputted to the motor and a coil electric current value detected from the motor into a motor model in which the motor is identified; and
a derivation unit configured to derive a magnetic flux deviation amount due to a distortion of a magnetic flux waveform of the motor according to the rotational position estimated by the estimation unit, wherein the estimation unit corrects the magnetic flux estimation value based on the magnetic flux deviation amount derived by the derivation unit, modifies the estimated rotational position based on the corrected magnetic flux estimation value, and outputs the modified rotational position.

2. The position estimation device as claimed in claim 1, wherein the derivation unit includes a storage unit configured to store magnetic flux deviation amounts due to distortions of magnetic flux waveforms of the motor measured at respective rotational positions of the rotator of the motor in association with the rotational positions of the rotator of the motor, and derives the magnetic flux deviation amount associated with the rotational position, which is estimated by the estimation unit, by reading out from the storage unit.

3. The position estimation device as claimed in claim 1, wherein the derivation unit includes a storage unit configured to store a high-order expression in which a magnetic flux deviation amount due to a distortion of a magnetic flux waveform of the motor is approximated as a harmonic component of the magnetic flux waveform, and derives the magnetic flux deviation amount by assigning the rotational position estimated by the estimation unit to the high-order expression.

4. The position estimation device as claimed in claim 1, wherein the estimation unit estimates a rotational velocity of the rotator of the motor based on the modified rotational position, and outputs the estimated rotational velocity.

5. A motor drive control device comprising the position estimation device as claimed in claim 4, wherein the rotational velocity of the rotator of the motor is controlled by feeding back the rotational velocity estimated by the estimation unit.

6. The motor drive control device as claimed in claim 5, further comprising:
a calculation unit configured to calculate an induced electric voltage deviation amount due to a distortion of an induced electric voltage based on the magnetic flux deviation amount derived by the derivation unit; and
a correction unit configured to correct the electric voltage instruction value to be inputted to the motor according to the induced electric voltage deviation amount calculated by the calculation unit.

7. A position estimation method for estimating a position of a rotator of a motor, comprising:
estimating a rotational position of the rotator of the motor using a magnetic flux estimation value of the motor, which is calculated by inputting an electric voltage instruction value to be inputted to the motor and a coil electric current value detected from the motor into a motor model in which the motor is identified;
deriving a magnetic flux deviation amount due to a distortion of a magnetic flux waveform of the motor according to the estimated rotational position; and
correcting the magnetic flux estimation value based on the derived magnetic flux deviation amount, modifying the estimated rotational position based on the corrected magnetic flux estimation value, and outputting the modified rotational position.

8. A non-transitory computer-readable storage medium storing a program for causing a computer of a position estimation device to execute a process of estimating a position of a rotator of a motor, the process comprising:
estimating a rotational position of the rotator of the motor using a magnetic flux estimation value of the motor, which is calculated by inputting an electric voltage instruction value to be inputted to the motor and a coil electric current value detected from the motor into a motor model in which the motor is identified;
deriving a magnetic flux deviation amount due to a distortion of a magnetic flux waveform of the motor according to the estimated rotational position; and
correcting the magnetic flux estimation value based on the derived magnetic flux deviation amount, modifying the estimated rotational position based on the corrected magnetic flux estimation value, and outputting the modified rotational position.
